(19) United States
(12) Patent Application Publication
(10) Pub. No.: US 2026/0129587 A1
(43) Pub. Date: May 7, 2026

(54) METHOD FOR OBTAINING POWER COMPENSATION VALUES WITH STATISTICAL DATA AND WIRELESS COMMUNICATION MODULE

(71) Applicant: AZUREWAVE TECHNOLOGIES, INC., NEW TAIPEI CITY (TW)

(72) Inventors: CHUN-HAO LIN, NEW TAIPEI CITY (TW); TING-HENG HAN, NEW TAIPEI CITY (TW); WU-YI CHEN, NEW TAIPEI CITY (TW); HSIN-YIN HU, NEW TAIPEI CITY (TW); YU-TIAN WEI, Shanghai (CN); WEI-CHIA HUNG, NEW TAIPEI CITY (TW)

(21) Appl. No.: 19/015,057

(22) Filed: Jan. 9, 2025

(30) Foreign Application Priority Data
Nov. 4, 2024 (TW) 113142027

(51) Int. Cl. H04W 52/22; H04B 17/26

(52) U.S. Cl. CPC H04W 52/225; H04B 17/26

(57) ABSTRACT

A method for obtaining power compensation values with statistical data and a wireless communication module are provided. The wireless communication module includes a wireless communication circuit that transmits wireless radio-frequency signals with a transmitting power, and a memory used to store a set of power-compensation values that are obtained using statistical data under multiple frequencies. In the method, the statistical data of the power-compensation values under multiple frequencies for the multiple wireless communication modules is obtained, data characteristics of the statistical data is referred to for estimating a power-compensation value corresponding to each frequency of the wireless communication module. Then, the multiple power-compensation values are written into the memory of the wireless communication module.

### CROSS-REFERENCE TO RELATED PATENT APPLICATION

This application claims the benefit of priority to Taiwan Patent Application No. 113142027, filed on Nov. 4, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of power compensation for a wireless communication module, and more particularly to a method for estimating power-compensation values for the wireless communication module based on association of statistical data.

### BACKGROUND OF THE DISCLOSURE

When a wireless communication module is manufactured, the transmit power of the wireless communication module is required to be compensated and checked so as to pass factory verification. FIG. 1 is a schematic diagram illustrating a test system for the wireless communication module. In the test system, a test instrument 10 is used to generate test data 101, such as the WiFi™ or Bluetooth™ communication signals. The signals are transmitted out via a wireless communication module 100. After that, the power 103 of the wireless communication module 100 under multiple frequency bands is measured. The measured values of power 103 can be compared with values of target power for obtaining power-compensation values, i.e., a compensated power is equal to a subtracting the measured power 103 from the target power.

The power-compensation values in the multiple frequency bands are then written to a memory 110 of the wireless communication module 100.

The memory 110 of the wireless communication module 100 can be a one-time programmable (OTP) memory such as an electrically-erasable programmable read-only memory (EEPROM) or an eFuse. When the power-compensation values are successfully written into the memory 110, the wireless communication module 100 can be shipped from the factory and used in various electronic devices.

The conventional method for calculating the compensation power for the wireless communication module is required to test and verify each of the channels; however, the verification may fail if the calculated compensation power fails to meet a specification, which means the power-compensation values are wrong. Thus, the whole processes such as adjustment, measurement, test and calculation need to be executed again, and a verification schedule for the wireless communication module will be postponed.

### SUMMARY OF THE DISCLOSURE

In order to reduce verification time for wireless communication modules by acquiring the power-compensation values more efficiently, the present disclosure provides a method for obtaining power-compensation values with statistical data and the wireless communication module that uses the power-compensation values obtained by the method.

In one aspect, in the method for obtaining power-compensation values with statistical data, statistical data of power-compensation values in multiple frequencies of the wireless communication module is obtained. One of the power-compensation values corresponding to each of the frequencies is then obtained based on data characteristics of the power-compensation values in each of the frequencies of the statistical data. Therefore, a set of power-compensation values for the wireless communication module in the multiple frequencies can be obtained and written into a memory of the wireless communication module.

Main circuit components of the wireless communication module include a wireless communication circuit and the memory. The wireless communication circuit is used to transmit radio-frequency signals with a transmit power via an antenna. The memory is used to store the multiple power-compensation values in the multiple frequencies that are obtained based on the statistical data for the wireless communication module.

In one further aspect of the present disclosure, the wireless communication module connects with a test platform via a connection interface. A test instrument of the test platform is used to measure the radio-frequency signals outputted by the wireless communication module via different channels under different configuration settings of ARF (Antenna-DataRate-Frequency).

Further, the transmit power of the radio-frequency signals under the different configuration setting of ARF can be obtained when the multiple wireless communication modules undergo measurement and testing by the test platform. After the values of the transmit power are compared with target values with respect to each of the configuration settings of ARF, the multiple power-compensation values can be obtained so as to form the above-mentioned statistical data. The power-compensation value can be transformed to power-compensation indexes through calculation with a transformation formula.

Furthermore, the data characteristics of the multiple power-compensation values in each of the frequencies of the statistical data are indicative of a distribution of statistics of the multiple power-compensation indexes in each of the frequencies of the multiple wireless communication modules.

Therefore, top power-compensation indexes of the statistics in each of the frequencies of the multiple wireless communication modules can form a range of critical compensation indexes for each of the frequencies. Then, one of the power-compensation indexes in each of the frequencies is chosen for each of the wireless communication modules.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a test system for a wireless communication module in one embodiment of the present disclosure;

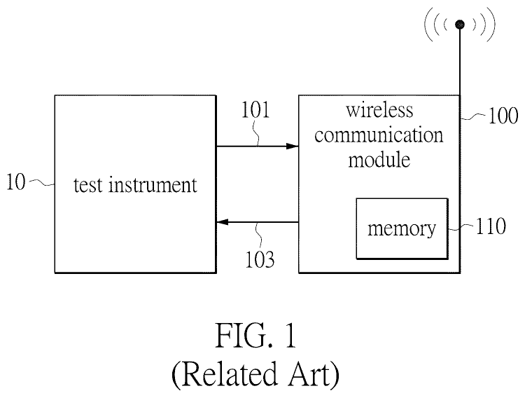

FIG. 2 is a schematic diagram illustrating a test framework for measuring transmit power and obtaining power-compensation values with statistical data according to one embodiment of the present disclosure;

FIG. 3 is a flowchart illustrating a method for obtaining power-compensation values with statistical data according to one embodiment of the present disclosure;

FIG. 4 is an example depicting a statistical table of a wireless communication module with compensation indexes in different frequencies;

FIG. 5 is a flowchart illustrating the method for obtaining power-compensation values with statistical data in one embodiment of the present disclosure; and

FIG. 6 is a flowchart illustrating a process of performing evaluation on operating performances with the power-compensation values in one embodiment of the present disclosure.

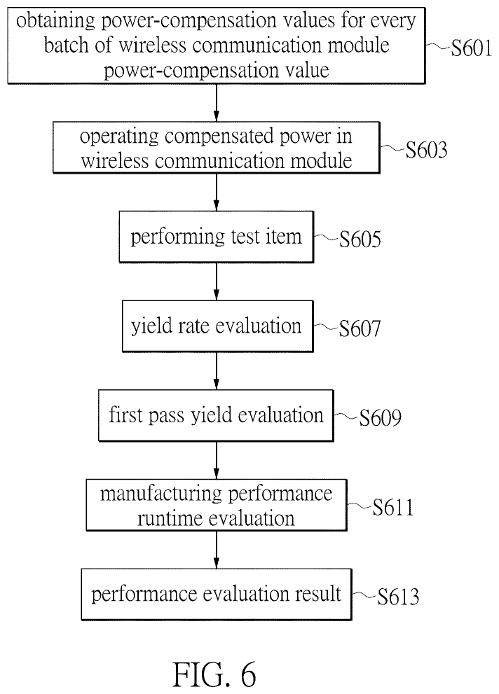

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for obtaining power-compensation values with statistical data and a wireless communication module. The main objective of the method is to obtain power-compensation value for the wireless communication module (or for an internal wireless communication circuit) in each of channels based on data characteristics of transmit power to be measured, and more efficiently to provide the power-compensation values to more wireless communication modules or related products with associations, e.g., the products having the same manufacturing project number. After that, the power-compensation values can be transformed to power-compensation indexes to be written to a memory of each of the wireless communication modules so that the time for testing and calibrating the wireless communication modules or the related products can be effectively reduced.

According to certain embodiments of the method for obtaining power-compensation values with statistical data of the present disclosure, every wireless communication module can be equipped with multiple antennas that can operate in different channels with different data rates. Various transmit power under different configuration settings of antenna-datarate-frequency (ARF) can be measured. It is assumed that the wireless communication modules (or internal wireless communication circuits) under the same manufacturing project should have similar data characteristics since the modules are manufactured within a similar period of time and with the same manufacturing process, and accordingly the power-compensation values for these wireless communication modules should have high association under different frequencies. Therefore, in the method for obtaining power-compensation values with statistical data, the power-compensation values for multiple wireless communication modules to be measured under different configuration settings of ARF can be referred to for estimating the power-compensation values under the other configuration settings of ARF. Further, in the method, the power-compensation values of the multiple wireless communication modules to be obtained from the statistical data can be applied to compensating the transmit power of each of the wireless communication modules that have the association.

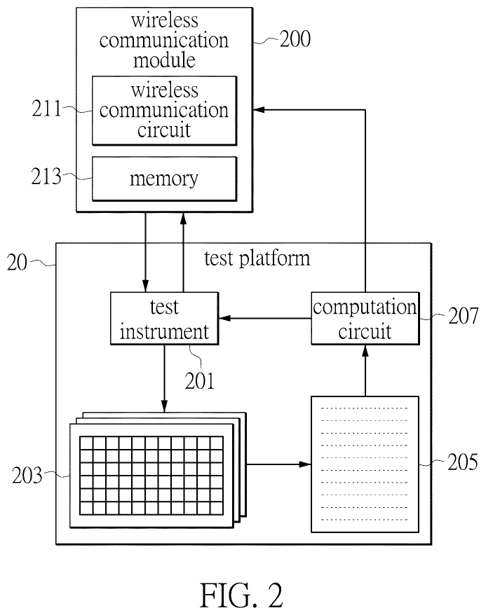

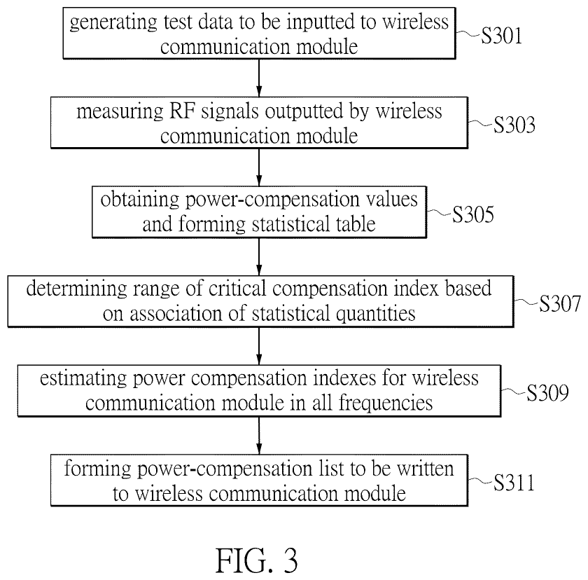

Reference is made to FIG. 2, which is a schematic diagram illustrating a test framework for measuring transmit power and operating the method for obtaining power-compensation values with statistical data according to one embodiment of the present disclosure, and the description is in view of FIG. 3, which is a flowchart illustrating the method according to one embodiment of the present disclosure.

The test framework shown in FIG. 2 provides a test platform 20 that can be implemented by a computer system that conducts computations and storage. The test platform 20 includes a test instrument 201 that connects with a wireless communication module 200 to be tested via a connection interface. Main circuit components of the wireless communication module 200 include a wireless communication circuit 211 having a transmit circuit (TX), a receive circuit (RX) and a memory 213. The wireless communication circuit 211 that is an integrated circuit used to perform a specific wireless communication protocol, signal encoding and decoding, and transmit/receive in the wireless communication module 200. The memory 213 is electrically connected with the wireless communication circuit 211. The memory 213 is used to store the power-compensation values corresponding to multiple frequencies that are obtained based on the statistical data for the wireless communication module 200.

When the wireless communication module 200 is under test, the test instrument 201 generates test data with a specific power and inputs the test data to the wireless communication module 200 (step S301). The wireless communication module 200 connects with an external device. The wireless communication circuit 211 is controlled to transmit radio-frequency signals with a transmit power via an antenna. Then the test instrument 201 measures the transmit power of the radio-frequency signals to be outputted under different configuration settings of ARF via different channels by the wireless communication module 200 so as to obtain multiple measured data (step S303).

Afterwards, a computation circuit 207 of the test platform 20 compares the measured values of the transmit power being obtained under different configuration settings of ARF and the target values corresponding to the different configuration settings of ARF, and obtains multiple power-compensation values. The power-compensation values can be expressed by compensation indexes. The compensation indexes for the multiple wireless communication modules in the same manufacturing project can be computed and used to establish a statistical table 203 (step S305). The statistical table 203 can be stored in a storage device of the test platform 20.

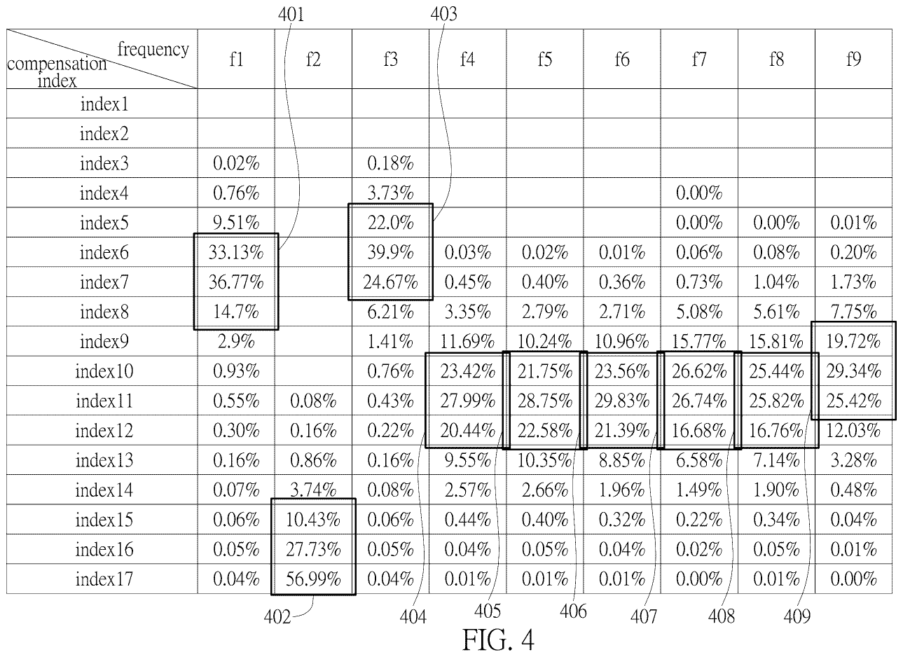

Reference is made to FIG. 4, which shows an example of the statistical table. The statistical table records multiple sets of compensation indexes (shown in a vertical axis) with respect to multiple frequencies (shown in a horizontal axis) of the multiple wireless communication modules. Through the statistical table, a distribution of the power-compensation values under each of the frequencies of the multiple wireless communication modules can be obtained based on the data characteristics. The present example shows that the computation circuit 207 performs statistics on the compensation indexes for obtaining a range of critical compensation indexes.

According to one of the embodiments of the present disclosure, the test instrument 201 obtains measured values by measuring the transmit power of the wireless communication module 200 and obtains differences by comparing the measured values and the target values. The differences are referred to for obtaining compensation values. The compensation values are used to calibrate the transmit power applied to the wireless communication module 200.

Based on specifications provided by different manufacturers for the wireless communication circuits, a transformation formula is provided to calculate the compensation indexes in compliance with one of the specifications set by each of the manufacturers. Therefore, the compensation values can be transformed to the compensation indexes based on the setting of the manufacturers. When the wireless communication module 200 is in operation of power compensation, the wireless communication circuit 211 can calculate a power-compensation value that is actually applied to the wireless communication module 200 for compensating the transmit power. Table 1 shows an exemplary example of the compensation indexes. Table 1 shows that a measured value is 16 dBm when actually measuring the wireless communication module 200. The system sets up a standard target value 16.5 dBm, a difference is obtained when comparing with the measured value and the target value and the difference is a compensated value 0.5 dBm. The present transformation formula uses a compensation step (e.g., 0.25 dBm) set by the system and a compensation index corresponding to the compensated value 0.5 dBm can be calculated, i.e., 2, as when 0.5 divided by 0.25 equals 2. Accordingly, the compensation index 2 is the value to be written into the memory 213 of the wireless communication module 200.

TABLE 1

| Item | Measured | target | Compensation | compensation |
|---|---|---|---|---|
| (unit: dBm) | value | value | value | index |
| Power | 16 | 16.5 | 0.5 | 2 |
| calibration | | | | |

Afterwards, in the method for obtaining power-compensation values with statistical data, the computation circuit 207 relies on the statistical data stored in the statistical table 203, which records associations among the multiple power-compensation values (or the power-compensation indexes), so as to obtain a statistical distribution. Therefore, data characteristics can be obtained from the statistical distribution, and the associations of the statistics can be used to determine a range of critical compensation indexes (step S307). A power-compensation value or the power-compensation index corresponding to each of the frequencies of every wireless communication module (or the related product) can be estimated based on the range of the critical compensation indexes (step S309). A power-compensation list 205 being applicable to the wireless communication modules in the same manufacturing project is generated. The power-compensation list 205 records the power-compensation values or the power-compensation indexes in each of the frequencies of the wireless communication modules in the same manufacturing project, so that a set of power-compensation indexes applied to each of the wireless communication modules are formed.

After that, the set of power-compensation values or the power-compensation indexes in the power-compensation list 205 are written to the memory 213 of the wireless communication module 200 via a connection interface (step S311). The memory 213 can be a one-time programmable (OTP) memory such as an electrically-erasable programmable read-only memory (EEPROM) or an eFuse.

According to certain embodiments of the method for obtaining power-compensation values with statistical data of the present disclosure, the method can be performed by a computer system, the data applied to the communication circuit (e.g., WiFi™ SoC or Bluetooth™ chip) of the wireless communication module is the compensation data provided by the manufacturer when the product is in delivery. Referring to FIG. 4, which is an exemplary example of the statistical table recording the compensation indexes under different frequencies of the wireless communication module, when the computer system obtains the compensation data, the statistical table is formed.

In the exemplary example shown in FIG. 4, a horizontal row of the statistical table denotes operating frequencies of the wireless communication modules that are manufactured in a same manufacturing project. The example of the horizontal row shows a part of the frequencies and is represented by f1, f2 to f9. A vertical column of the statistical table denotes the compensation indexes that are calculated from the compensation data in different frequencies of the wireless communication modules provided by the manufacturer. The example of the vertical column shows a part of the compensation indexes and is represented by index1, index2 to index17. The percentage values shown in the example denote quantity percentage of each of the compensation indexes in each of the frequencies of the wireless communication modules in the same manufacturing project. It should be noted that the statistical data used in the method for obtaining the power-compensation values is not limited to the values of the example, but can be any of the various statistics (e.g., an average, a standard deviation or any self-defined index) that can reflect the data characteristics of the multiple power-compensation values in each of the frequencies of an integrated circuit (IC) of the wireless communication module. The self-defined index is such as, but not limited to, a correlation coefficient, statistics of a cumulative distribution, statistics of a non-defective distribution, or statistics of a first pass yield (FPY). The non-defective distribution indicates a cumulative quality of a single measurement item in different configuration settings of ARF of every wireless communication module. The first pass yield indicates a combined statistics that the wireless communication module passes all test items at the first time.

Reference is made to FIG. 4, which is an example of a statistical table that can be used to obtain a distribution of statistics of power-compensation indexes in each of frequencies of a wireless communication module. The distribution of statistics is such as a statistical distribution of quantity that can be referred to for determining a range of critical compensation indexes, for example the critical compensation indexes 401, 402, 403, 404, 405, 406, 407, 408 and 409 in each of the frequencies. Afterwards, one of the compensation indexes in each of the frequencies will be determined based on the distribution. Thus, based on the association of transmit power in different configuration settings of ARF of the multiple wireless communication modules, the power-compensation indexes in each of the frequencies can be obtained and also applicable to the multiple wireless communication modules that are associated or in the same manufacturing project.

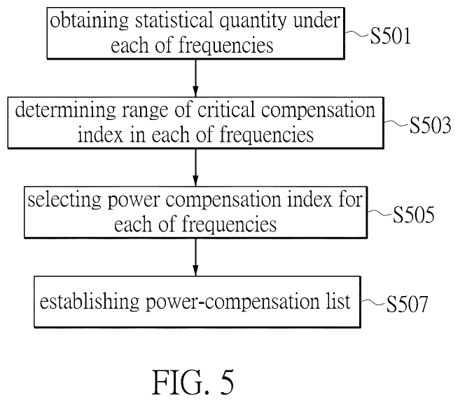

In view of the example of the statistical table shown in FIG. 4, reference is next made to FIG. 5, which is a flowchart illustrating the method for obtaining power-compensation values with statistical data according to one embodiment of the present disclosure.

Based on the statistics of quantity with respect to individuals of the power-compensation indexes for the multiple wireless communication modules in multiple frequencies, the example shown in FIG. 4 provides the statistics of quantity in percentage. It should be noted that the example shown in the figure is not used to limit practical applications of the method, but various statistics that can be used to extract the statistical features can be adopted in the method (step S501). Thus, the critical power-compensation values can be selected from the distribution of the statistics. For example, some critical compensation indexes with higher quantity in each of the frequencies can be obtained based on the distribution of statistics so as to form a range of critical compensation indexes (step S503). Several power-compensation indexes with top quantity (e.g., top three in the example) of statistics (e.g., quantity percentage) can be selected to form the range of critical compensation indexes. Next, in an exemplary example, the power-compensation index with, but not limited to, a middle statistical value can be selected from the range of critical compensation indexes and applied to the multiple wireless communication modules in one of the frequencies (step S505).

According to the example shown in FIG. 4, the critical compensation index with a middle value of the statistics is selected from the range of critical compensation indexes 401, 402, 403, 404, 405, 406, 407, 408 and 409 in one of the frequencies, and the selected critical compensation index is used as the power-compensation index applied to the wireless communication module in the one of the frequencies. According to the example, in the range of critical compensation indexes 401 in frequency f1, 33.13% of the quantity of the wireless communication modules have the compensation index of “−3”, 36.77% of the quantity of the wireless communication modules have the compensation index of “−2”, and 14.7% of the quantity of the wireless communication modules have the compensation index of “−1.” After that, a middle value of the critical compensation indexes in the range of critical compensation indexes 401 can be used as the compensation index applied to the wireless communication module in frequency f1, and accordingly the compensation index of “−2” is decided. Taking the frequency f3 as an example, top three quantity percentages of the critical compensation indexes of the wireless communication modules in frequency f3 form a range of critical compensation indexes 403, in which 22.0% of the quantity of the wireless communication modules have the compensation index of “−4”, 39.9% of the quantity of the wireless communication modules have the compensation index of “−3”, and 24.67% of the quantity of the wireless communication modules have the compensation index of “−2.” A middle value of the critical compensation indexes in the range of critical compensation indexes 403 is used as the compensation index applied to the wireless communication module in frequency f3, and accordingly the compensation index of “−3” is decided. Similarly, taking frequency f4 as an example, a middle value of the critical compensation indexes in the range of critical compensation indexes 404 is used as the compensation index applied to the wireless communication module in frequency f4, and accordingly the compensation index of “2” is decided. Thus, the compensation indexes in the frequencies of the wireless communication module are finally decided and used to establish a power-compensation list. The power-compensation list records the compensation index applied to the wireless communication module in each of the frequencies and is written to a memory of the wireless communication module via a write circuit (step S507).

It should be noted that the compensation index is a value to be written into the memory of the wireless communication module, and can be replaced by any value used to represent a compensated power. One of the calculations of the compensation index is as follows, but is not used to limit the practical application of the method.

A test platform is used to measure transmit power of the wireless communication module so as to obtain a measure power, and calculate a difference between the measure power and a target power that is in compliance with a standard. The difference indicates a compensation power, i.e., the compensation power equals to subtracting the measure power by the target power. Afterwards, a transformation formula set by the system is used to calculate a compensation index. Thus, when the wireless communication module is in operation, the compensation index should be recovered to a practical compensation power by the transformation formula, so that the wireless communication module can operate in the target power in every frequency.

It is worth noting that, since the communication circuits of the multiple wireless communication modules in a same manufacturing project are manufactured under a same manufacturing and testing environment, the multiple wireless communication modules will have the similar power-compensation values, so that the power-compensation indexes being applied to the multiple communication modules in various frequencies can be determined in a statistical manner. On the contrary, the data of wireless communication modules being manufactured in different manufacturing project will form different statistical distributions due to the different manufacturing and testing environments or the like. Therefore, the statistical table and the compensation indexes to be obtained based on the statistical distribution shown in FIG. 4 can be dynamically changed based on actual conditions.

After that, the test platform obtains the power-compensation values or the compensation indexes being applied to the wireless communication modules in each of the frequencies and then writes the power-compensation values or the compensation indexes to the memory of each of the wireless communication modules, and also verifies the modules before delivery. Since the data measured from the wireless communication modules being manufactured in the same manufacturing project have an association, the method for obtaining power-compensation values with statistical data can be used to obtain the power-compensation values applicable to the wireless communication modules with the association. The power-compensation values or the power-compensation indexes can be effectively obtained and applied to the wireless communication modules.

Further, when the wireless communication module is in operation with the compensated power, a process for evaluating operating performance of the wireless communication module is performed.

Referring to FIG. 5, when the power-compensation values applicable to every batch of the wireless communication modules are obtained through the method for obtaining power-compensation values with statistical data (step S601), the wireless communication modules can operate with the compensated power (step S603). After that, the operating performance of the wireless communication module is evaluated.

Thus, the batches of the wireless communication modules are tested with multiple test items on a test platform (step S605). For example, the test items such as, but not limited to, an output power, an operating bandwidth and product stability are measured when the wireless communication module is in operation with the compensated power, and then the test platform determines whether the wireless communication module meets the required specification.

Next, the operating performance of the wireless communication module can be evaluated according to test results of the above test items. One of indicators for evaluating the operating performance is yield rate (step S607), which indicates a proportion of the wireless communication modules that pass one of the test items; another indicator for evaluating the operating performance is first-pass yield (step S609), which indicates another proportion of the wireless communication modules that meet the production specification in all of the test items at the first time; and one further indicator for evaluating the operating performance is a total test time or a cycle time (step S611), which indicates an improvement time of an average manufacturing time of the wireless communication modules that apply the compensated power provided by the above-described method relative to an average manufacturing time of the wireless communication modules that apply the power before applying the above-described method of the present disclosure or to be compensated by other methods.

Finally, an evaluation result of the operating performance of the wireless communication modules based on any of the above-described indicators can be obtained (step S613). For example, the yield rate evaluation indicative of the proportion of the wireless communication modules that pass one single test item should be larger than or equal to 90%; the first pass yield evaluation indicative of the proportion of the wireless communication modules that meet the production specification in all of the test items at the first time should be larger than or equal to 70%; and a runtime evaluation (e.g., the total test time or the cycle time) indicative of the improvement time for manufacturing performance should be smaller than or equal to 300 seconds.

In conclusion, according to the above embodiments of the method for obtaining power-compensation values with statistical data and the wireless communication module of the present disclosure, the association among the statistical data in the configuration settings of the antenna-datarate-frequency is referred to for estimating the power-compensation values in different configuration settings of antenna-datarate-frequency of the wireless communication modules in the same manufacturing project. Accordingly, with the requirement of maintaining communication quality of the product, the test and calibration time for the wireless communication modules or related products can be effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for obtaining power-compensation values with statistical data, comprising:
acquiring statistical data of power-compensation values of multiple wireless communication modules in multiple frequencies;
estimating a set of power-compensation values in the multiple frequencies for each of the multiple wireless communication modules based on data characteristics of the multiple power-compensation values in each of the frequencies of the statistical data; and
writing the set of power-compensation values in the multiple frequencies to a memory of each of the wireless communication modules.

2. The method according to claim 1, wherein, through a test platform, the multiple wireless communication modules undergo measurement and testing so as to acquire multiple values of transmit power under different configuration settings of antenna-datarate-frequency, and the multiple measured values of transmit power are compared with multiple target values for obtaining the multiple power-compensation values that form the statistical data.

3. The method according to claim 2, wherein each of the multiple power-compensation values of the statistical data is transformed to a power-compensation index by a transformation formula.

4. The method according to claim 3 wherein the data characteristics of the multiple power-compensation values in each of the frequencies of the statistical data denotes a distribution of statistics of the multiple power-compensation indexes in each of the frequencies.

5. The method according to claim 4, wherein, a number of top power-compensation indexes of the statistics in each of the frequencies of the multiple wireless communication modules form a range of critical compensation indexes for each of the frequencies, and one of the power-compensation indexes in each of the frequencies is chosen for each of the wireless communication modules.

6. A wireless communication module, comprising:
a wireless communication circuit that transmits radio-frequency signals with a transmit power via an antenna; and
a memory electrically connected with the wireless communication circuit, and storing a set of power-compensation values obtained from statistical data under multiple frequencies of the wireless communication module, wherein the multiple power-compensation values are obtained by a method comprising:
acquiring the statistical data of power-compensation values of multiple of the wireless communication module in multiple frequencies;
estimating the set of power-compensation values in the multiple frequencies for each of the multiple wireless communication modules based on data characteristics of the multiple power-compensation values in each of the frequencies of the statistical data; and
writing the set of power-compensation values in the multiple frequencies to the memory of each of the wireless communication modules.

7. The wireless communication module according to claim 6, wherein the wireless communication module connects with a test platform via a connection interface, in which a test instrument is used to measure radio-frequency signals outputted by the wireless communication module via different channels under different configuration settings of antenna-datarate-frequency.

8. The wireless communication module according to claim 7, wherein, through a test platform, the multiple wireless communication modules undergo measurement and testing so as to acquire multiple values of transmit power under the different configuration settings of antenna-datarate-frequency, and the multiple measured values of transmit power are compared with multiple target values for obtaining the multiple power-compensation values that form the statistical data; and each of the multiple power-compensation values of the statistical data is transformed to a power-compensation index by a transformation formula.

9. The wireless communication module according to claim 8, wherein the data characteristics of the multiple power-compensation values in each of the frequencies of the statistical data denotes a distribution of statistics of the multiple power-compensation indexes in each of the frequencies.

10. The wireless communication module according to claim 9, wherein, a number of top power-compensation indexes of the statistics in each of the frequencies of the multiple wireless communication modules form a range of critical compensation indexes for each of the frequencies, and one of the power-compensation indexes in each of the frequencies is chosen for each of the wireless communication modules.
